(19) United States
(12) Patent Application Publication
(10) Pub. No.: US 2016/0229969 A1
(43) Pub. Date: Aug. 11, 2016

(54) MULTIBLOCK COPOLYMER FILMS WITH INORGANIC NANOPARTICLES, METHODS OF MAKING SAME, AND USES THEREOF

(71) Applicant: Cornell University, Ithaca, NY (US)

(72) Inventors: Ulrich WIESNER, Ithaca, NY (US); Yibei GU, Ithaca, NY (US)

(73) Assignee: Cornell University, Ithaca, NY (US)

(21) Appl. No.: 15/024,727

(22) PCT Filed: Sep. 25, 2014
(86) PCT No.: PCT/US14/57389

§ 371 Date: Mar. 24, 2016

Related U.S. Application Data
(60) Provisional application No. 61/882,081, filed on Sep. 25, 2013.

(51) Int. Cl. C08J 9/00; B01D 69/14; B01D 67/00; B01D 71/28; B01D 71/80; C08J 9/28; B01D 71/02

(52) U.S. Cl. CPC C08J 9/008; C08J 9/28; B01D 69/148; B01D 71/024; B01D 71/28; B01D 71/80; B01D 67/0079; C08J 2201/0542; C08J 2353/00; B01D 2325/022; B01D 2325/04

(57) ABSTRACT

Asymmetric organic-inorganic films and methods for forming and using such films. For example, the films are used as membranes for selective separation applications. The methods combine co-assembly of block copolymer (BCP) and inorganic nanoparticles (NPs), such as, for example, titanium dioxide (TiO₂), with non-solvent induced phase separation. The resulting films exhibit structural asymmetry. For example, the films have a thin nanoporous surface layer on top of a macroporous finger-like support layer. Parameters that may dictate membrane morphology include the fraction of inorganic nanoparticles used and the length of time allowed for surface layer development. In filtration tests, the resulting membranes show both desirable selectivity and permeability. The synthesis methods for hybrid membranes provide a new self-assembly platform upon which multi-functional and high-performance organic-inorganic membranes can be formed.

### CROSS-REFERENCE TO RELATED APPLICATIONS

This application claims priority to U.S. provisional patent application No. 61/882,081, filed Sep. 25, 2013, the disclosure of which is incorporated herein by reference.

### STATEMENT REGARDING FEDERALLY SPONSORED RESEARCH

This invention was made with government support under Grant No. DMR-1104773 awarded by the National Science Foundation. The Government has certain rights in the invention.

### FIELD OF THE DISCLOSURE

The field of the disclosure generally relates to multiblock copolymer films with inorganic nanoparticles and methods of making and using same. More particularly, the disclosure relates to such films having a separation layer and a support layer.

### BACKGROUND OF THE DISCLOSURE

Polymeric phase inverted membranes have been used extensively over the past several decades. Block copolymer (BCP) self-assembly is a method for achieving well-ordered, periodic structures on length scales of about 5 to about 50 nm. If porosity in BCP based films is desired, as it is for many separation applications, it was typically achieved by selective removal of one of the blocks, adding multiple post treatment steps to the fabrication process. However, their applications are often limited by their chemical functionality.

Aside from the addition of inorganic salts, BCP based films have to date been limited to organic materials. Small amounts (˜0.15 wt % in the solvent) of metal ions have previously been added into the casting solution which incorporates (or decorates) metal ions on the outer surface of the membrane.

### BRIEF SUMMARY OF THE DISCLOSURE

The disclosure demonstrates the fabrication of asymmetric organic-inorganic films by marrying BCP and inorganic nanoparticle (NP) co-assembly and non-solvent induced phase separation. It is a facile “one-pot” type process incorporating inorganic nanoparticles at significant weight fractions (e.g., up to 50 wt %) in the final film and is thus expected to be amenable to large scale film fabrication.

In an embodiment, the BCP used for film fabrication is the triblock terpolymer poly(isoprene-b-styrene-b-4-vinylpyridine) (ISV) with volume fractions of 0.30, 0.55 and 0.15 for polyisoprene, polystyrene and poly(4-vinylpyridine) blocks, respectively. Alternatively, different volume fractions of the block may also be used. The BCP's that are used are not restricted to any specific size, but can be different molar masses (Mₙ).

Titanium, in the form of the metal oxide TiO₂, was used as the inorganic component. Other inorganic components such as metals, metal oxides, aluminosilicates nanoparticles (such as silica and transition metal and transition metal oxide nanoparticles) can be incorporated). The inorganic content of the film can be, for example, about 3 wt % to about 50 wt % or more.

For example, the films exhibit structural asymmetry with a thin nanoporous surface layer on top of macroporous finger-like support layer. The films can show both desirable selectivity and permeability.

In an embodiment, an asymmetric organic-inorganic film comprises a multiblock copolymer having at least two blocks that microphase separate, and a plurality of inorganic nanoparticles disposed within at least a portion of the film and on at least a portion of the film surface. The film has a surface layer having a thickness of 20 nm to 500 nm and a plurality of pores having a diameter or equivalent circular diameter of 5 nm to 100 nm. The film has a support layer having a thickness of 5 microns to 500 microns and a plurality of pores having a diameter or equivalent circular diameter of 1 micron to 50 microns. In an embodiment, in the asymmetric organic-inorganic film the pores increase in size (i.e., have a gradient) moving in the direction from the surface layer towards the support layer.

In an embodiment, a plurality of the pores in the support layer lie on a plane that is 20 microns from the surface layer and parallel to the surface layer-support layer interface of the film have a diameter or equivalent circular diameter in the plane of at least 5 microns. In an embodiment, at least a portion of the pores in the support layer have an aspect ratio of greater than 2. In an embodiment, at least a portion of the pore surface (e.g., pore wall) in the support layer is mesoporous (e.g., has one or more pores having an equivalent circular diameter of 5 nm to 100 nm).

In an embodiment, the multiblock copolymer has a PDI of 1.0 to 2.0.

In an embodiment, the inorganic nanoparticles have a diameter of 1 nm to 20 nm. In an embodiment, the inorganic nanoparticles are present in the film at 0.1 percent by weight to 50 percent by weight. In an embodiment, the film has a thickness of 2 microns to 50 microns.

In an embodiment, the film further comprises a homopolymer and/or small molecule. In an embodiment, the molar ratio of multiblock copolymer to homopolymer is from 1:0.05 to 1:10 and/or the molar ratio of multiblock copolymer to small molecule is from 1:1 to 1:1000.

In an embodiment, a method for forming an asymmetric organic-inorganic film comprising a multiblock copolymer having at least two blocks that microphase separate comprises a) using a deposition solution comprising the multiblock copolymer, inorganic nanoparticles, and a solvent to form an initial film comprising the multiblock copolymer, inorganic nanoparticle, and the solvent on a substrate, b) removing a portion of the solvent from the initial film, and contacting the film from b) with a phase separation solvent system, such that the asymmetric organic-inorganic film having a plurality of inorganic nanoparticles disposed within at least a portion of the film and on at least a portion of the film surface, a surface layer having a thickness of 20 nm to 500 nm and a plurality of pores having a diameter 5 nm to 100 nm in size, and a support layer having a thickness of 5 microns to 500 microns and pores having a diameter or equivalent circular diameter of 1 micron to 50 microns is formed. In an embodiment, the film from b) is contacted with a vapor-phase phase separation solvent system (i.e., a phase separation solvent system in the vapor phase).

In an embodiment, the inorganic nanoparticles are present in the deposition solution at 0.1 percent by weight to 50 percent by weight of the solution (also referred to herein as wt %). In an embodiment, the deposition solution further comprises a homopolymer and/or a small molecule and the film further comprises the homopolymer or the small molecule.

In an embodiment, the solvent comprises a solvent selected from the group consisting of tetrahydrofuran, 1,4-dioxane, morpholine, formylpiperidine, methanol, ethanol, toluene, chloroform, dimethylformamide, acetone, dimethylsulfoxide, dimethylacetamide, N-methylpyrrolidone, sulfolane, and combinations thereof. In an embodiment, the concentration of multiblock copolymer in the deposition solution is 5 percent by weight to 50 percent by weight.

In an embodiment, a device comprises the asymmetric organic-inorganic film (or asymmetric organic-inorganic film made by a method of the present disclosure). In an embodiment, the device is a filtration device.

### BRIEF DESCRIPTION OF THE FIGURES

For a fuller understanding of the nature and objects of the disclosure, reference should be made to the following detailed description taken in conjunction with the accompanying figures:

FIG. 1. (Scheme 1) ISV in THF/DOX and TiO₂ sol NPs in THF are mixed into a casting solution with a known concentration of ISV in a final solvent mixture of 3/7 (by weight) THF/DOX. The casting solution is cast onto a glass slide into a film by doctor blade at a gate height of 220 μm. The film is allowed to evaporate a specified time and is then immersed into a coagulation bath of deionized water. (PI)=polyisoprene block; (PS)=polystyrene block (PV)=poly(4-vinylpyridine) block.

FIG. 2. SEM micrographs of asymmetric organic-inorganic films cast from ISV43 solutions with 11 wt % TiO₂. From left to right, the full cross-section, the bottom surface, the magnified top surface cross-section and top surface structure are shown. Films cast from the 0.07 ISV43 weight ratio solution, and evaporated for (a) 30 sec, (b) 45 sec, (c) 60 sec, before immersion. (d) Film cast from a 0.09 ISV43 weight ratio solution, and evaporated for 30 sec before immersion.

FIG. 3. SEM micrographs of the films cast from the 0.07 ISV91 weight ratio solution and evaporated for 45 sec. Film cast from solution of (a) purely ISV91 (without TiO₂); (b) ISV91 with 3 wt % TiO₂; (c) ISV91 with 26 wt % TiO₂.

FIG. 4. SEM micrographs of films cast from the 0.07 ISV91 weight ratio solutions with (a) 3 wt % TiO₂, (b) 21 wt % TiO₂, at different evaporation times. Scale bar is 100 nm in all images.

FIG. 5. SEM images of four films with different inorganic fractions prepared from 0.07 ISV91 solutions and evaporated for 75 sec. The inorganic loadings in the casting solution were 3 wt %, 7 wt %, 15 wt % and 21 wt % for M1, M2, M3 and M4, respectively. Scale bar is 100 nm in all images.

FIG. 6. (a) DI water fluxes for CNIPS film M4 at various trans-film pressures. (b) Molecular weight cut off curves from two films cast under the same conditions. Circles (M4-1, applied pressure˜0.02 bar) and triangles (M4-2, applied pressure˜0.03 bar) show consistent rejection results.

FIG. 7. TGA curve obtained from a dried film cast from an ISV43 with 11 wt % TiO₂ in the casting solution.

FIG. 8. TGA curves obtained from dried films cast from ISV91 (M1, M2, M3 and M4). The retained weights at 560° C. were 3 wt %, 7 wt %, 11 wt %, and 15 wt % for the four films M1-M4, respectively.

FIG. 9. SEM micrographs of large area top surfaces of M1 and M4.

### DETAILED DESCRIPTION OF THE DISCLOSURE

The present disclosure provides asymmetric multiblock copolymer-inorganic nanoparticle films. Also provided are methods of making such films and uses of such films.

The present disclosure is based on the surprising result that the incorporation of inorganic nanoparticles in the deposition solution used to form asymmetric organic-inorganic films with a separation layer and support layer provides films having support layers with desirable pore structure. Inclusion of inorganic nanoparticles (NPs) to produce asymmetric organic-inorganic films combines one or more of the properties of the inorganics, such as, for example, mechanical and thermal stability, chemical activity (e.g., catalytic activity), photochemical reactivity (which can provide self-cleaning properties to the film), antimicrobial behavior, pressure resistivity, anti-fouling behavior, and high permeability.

As used herein equivalent circular diameter means the diameter of the smallest circle which entirely encloses an object. This term is used to describe the size of non-symmetric objects. For example, the size of non-symmetric pores in the support layer is referred to as equivalent circular support layer pore diameter.

As used herein small molecule means a molecule having a molar mass of 1000 g/mol or less. For example, the small molecule is an organic molecule.

In an aspect, the present disclosure provides methods of making asymmetric organic (multiblock copolymer)-inorganic nanoparticle films. The films are also referred to herein as hybrid films or membranes. The methods use a deposition solution (also referred to as a “dope”) that comprises a multiblock copolymer and inorganic nanoparticles. The films have a separation layer and a support layer. In an embodiment, the films are graded. In an embodiment, an asymmetric organic copolymer-inorganic nanoparticle film is made by a method disclosed herein. In an embodiment, the method is the CNIPS process described in the examples.

In an embodiment, the method for forming an asymmetric organic-inorganic film comprising a multiblock copolymer comprises: using a deposition solution comprising the multiblock copolymer, inorganic nanoparticles, and a solvent to form an initial film comprising the multiblock copolymer, inorganic nanoparticle, and the solvent on a substrate; removing a portion of the solvent from the initial film; and contacting the film resulting from removal of a portion of the solvent from the initial film with a phase separation solvent system, such that the asymmetric organic-inorganic film is formed.

The deposition solution is used to form a film comprising the multiblock copolymer on the substrate. This film may be referred to as an initial film. The deposition solution includes at least a multiblock copolymer, inorganic nanoparticles, and a solvent.

Any substrate on which a layer comprising a multiblock copolymer can be formed can be used. A wide range of substrate materials, sizes, and shapes can be used. The substrate can be solid or porous. Examples of suitable substrates include glass plates or rods, silicon, plastic (e.g., Teflon™) porous film supports such as non-woven polyester, or any combination of the above. For example, non-woven polyester on top of glass can be used as a substrate.

A variety of multiblock copolymers can be used. The multiblock copolymers have at least two blocks that microphase separate. By microphase separate it is meant that the multiblock copolymers self-assemble into structures (e.g., micelles, hexagonally-packed cylinders, or disordered but mesophase structure.) with mesoscale domains (e.g., domains having a longest dimension of 2 nm to 50 nm). In an embodiment, a mesoporous domain is comprised of one block of the block copolymer and is adjacent to a mesoporous domain of a chemically distinct block of the block copolymer. There may be multiple chemically distinct domains depending on the number of blocks in the multiblock copolymer.

The multiblock copolymers can be synthesized by methods known in the art. For example, the copolymers can be synthesized using anionic polymerization, atom transfer radical polymerization (ATRP), or other suitable polymerization techniques. The multiblock copolymers can be also be obtained commercially.

In various examples, the multiblock copolymer has a structure of form A-B or A-B-A or A-B-C, where A or B or C is polystyrene, poly-4-vinylpyridine, poly-2-vinylpyridine, polybutadiene, polyisoprene, poly(ethylene-stat-butylene), poly(ethylene-alt-propylene), polysiloxane, polyalkylenoxide, poly-ε-caprolactone, polylactide, polyalkylmethacrylate, polymethacrylic acid, polyalkylacrylate, polyacrylic acid, polyhydroxyethylmethacrylate, polyacrylamide, poly-N-alkylacrylamide, polyethylene oxide, polydimethylaminoethylmethacrylate, poly-tert-butylstyrene, or polyhydroxystyrene. In various embodiments, the multiblock copolymer is a triblock terpolymer having a structure of the form A-B-C, or A-C-B, or other variable arrangements or containing blocks of different chemical composition. In other embodiments, additional structures are higher order multi-block copolymer systems of the form A-B-C-B, or A-B-C-D, or A-B-C-B-A, or A-B-C-D-E, or other variable arrangements of these higher order systems.

Examples of suitable diblock copolymers include poly(styrene)-b-poly((4-vinyl)pyridine), poly(styrene)-b-poly((2-vinyl) pyridine), poly(styrene)-b-poly(ethylene oxide), poly(styrene)-b-poly(methyl methacrylate), poly(styrene)-b-poly(acrylic acid), poly(styrene)-b-poly(dimethylethyl amino ethyl methacrylate), poly(styrene)-b-poly(hydroxystyrene), poly(α-methyl styrene)-b-poly((4-vinyl)pyridine), poly(α-methyl styrene)-b-poly((2-vinyl) pyridine), poly(α-methyl styrene)-b-poly(ethylene oxide), poly(α-methyl styrene)-b-poly(methyl methacrylate), poly(α-methyl styrene)-b-poly(acrylic acid), poly(α-methyl styrene)-b-poly(dimethylethyl amino ethyl methacrylate), poly(α-methyl styrene)-b-poly(hydroxystyrene), poly(isoprene)-b-poly((4-vinyl)pyridine), poly(isoprene)-b-poly((2-vinyl) pyridine), poly(isoprene)-b-poly(ethylene oxide), poly(isoprene)-b-poly(methyl methacrylate), poly(isoprene)-b-poly(acrylic acid), poly(isoprene)-b-poly(dimethylethyl amino ethyl methacrylate), poly(isoprene)-b-poly(hydroxystyrene), poly(butadiene)-b-poly((4-vinyl)pyridine), poly(butadiene)-b-poly((2-vinyl) pyridine), poly(butadiene)-b-poly(ethylene oxide), poly(butadiene)-b-poly(methyl methacrylate), poly(butadiene)-b-poly(acrylic acid), poly(butadiene)-b-poly(dimethylethyl amino ethyl methacrylate), poly(butadiene)-b-poly(hydroxystyrene), poly(4-tert-butylstyrene)-b-poly((4-yinyl)pyridine), poly(4-tert-butylstyrene)-b-poly((2-vinyl) pyridine), poly(4-tert-butylstyrene)-b-poly(ethylene oxide), poly(4-tert-butylstyrene)-b-poly(methyl methacrylate), poly(4-tert-butylstyrene)-b-poly(acrylic acid), poly(4-tert-butylstyrene)-b-poly(dimethylethyl amino ethyl methacrylate), poly(hydroxystyrene)-b-poly((4-vinyl)pyridine), poly(hydroxystyrene)-b-poly((2-vinyl) pyridine), and poly(hydroxystyrene)-b-poly(ethylene oxide).

Examples of suitable triblock copolymers include poly(isoprene-b-styrene-b-4-vinylpyridine), poly(isoprene)-b-poly(styrene)-b-poly((4-vinyl)pyridine), poly(isoprene)-b-poly(styrene)-b-poly((2-vinyl) pyridine), poly(isoprene)-b-poly(styrene)-b-poly(ethylene oxide), poly(isoprene)-b-poly(styrene)-b-poly(methyl methacrylate), poly(isoprene)-b-poly(styrene)-b-poly(acrylic acid), poly(isoprene)-b-poly(styrene)-b-poly(dimethylethyl amino ethyl methacrylate), poly(isoprene)-b-poly(styrene)-b-poly(hydroxystyrene), poly(isoprene)-b-poly(α-methyl styrene)-b-poly((4-vinyl)pyridine), poly(isoprene)-b-poly(α-methyl styrene)-b-poly((2-vinyl) pyridine), poly(isoprene)-b-poly(α-methyl styrene)-b-poly(ethylene oxide), poly(isoprene)-b-poly(α-methyl styrene)-b-poly(methyl methacrylate), poly(isoprene)-b-poly(α-methyl styrene)-b-poly(acrylic acid), poly(isoprene)-b-poly(α-methyl styrene)-b-poly(dimethylethyl amino ethyl methacrylate), poly(butadiene)-b-poly(styrene)-b-poly((4-vinyl)pyridine), poly(butadiene)-b-poly(styrene)-b-poly((2-vinyl) pyridine), poly(butadiene)-b-poly(styrene)-b-poly(ethylene oxide), poly(butadiene)-b-poly(styrene)-b-poly(methyl methacrylate), poly(butadiene)-b-poly(styrene)-b-poly(acrylic acid), poly(butadiene)-b-poly(styrene)-b-poly(dimethylethyl amino ethyl methacrylate), poly(butadiene)-b-poly(styrene)-b-poly(hydroxystyrene), poly(butadiene)-b-poly(α-methyl styrene)-b-poly((4-vinyl)pyridine), poly(butadiene)-b-poly(α-methyl styrene)-b-poly((2-vinyl) pyridine), poly(butadiene)-b-poly(α-methyl styrene)-b-poly(ethylene oxide), poly(butadiene)-b-poly(α-methyl styrene)-b-poly(methyl methacrylate), poly(butadiene)-b-poly(α-methyl styrene)-b-poly(acrylic acid), poly(butadiene)-b-poly(α-methyl styrene)-b-poly(dimethylethyl amino ethyl methacrylate), poly(butadiene)-b-poly(styrene)-b-poly(hydroxystyrene), poly(isoprene-b-4-tertbutylstyrene-b-4-vinylpyridine), poly(isoprene)-b-poly(4-tertbutylstyrene)-b-poly((4-vinyl)pyridine), poly(isoprene)-b-poly(4-tertbutylstyrene)-b-poly((2-vinyl) pyridine), poly(isoprene)-b-poly(4-tertbutylstyrene)-b-poly(ethylene oxide), poly(isoprene)-b-poly(4-tertbutylstyrene)-b-poly(methyl methacrylate), poly(isoprene)-b-poly(4-tertbutylstyrene)-b-poly(acrylic acid), poly(isoprene)-b-poly(4-tertbutylstyrene)-b-poly(dimethylethyl amino ethyl methacrylate), and poly(isoprene)-b-poly(4-tertbutylstyrene)-b-poly(hydroxystyrene).

In an embodiment, the multiblock copolymer has at least one hydrogen-bonding block. The hydrogen-bonding block can self-assemble with another structurally distinct polymer block of the multiblock copolymer (e.g., a hydrophobic block). The hydrogen-bonding block has an acceptor group or donor group that can participate in intramolecular hydrogen bonding. The hydrogen-bonding block can be a hydrophilic block. Examples of suitable hydrogen-bonding blocks include poly((4-vinyl)pyridine), poly((2-vinyl) pyridine), poly(ethylene oxide), poly(methacrylates) such as poly(methacrylate), poly(methyl methacrylate), and poly(dimethylethyl amino ethyl methacrylate), poly(acrylic acid), and poly(hydroxystyrene). In an embodiment, the hydrophilic block is poly((4-vinyl)pyridine).

In this embodiment, the multiblock copolymer has additional blocks that are hydrophobic blocks. The hydrophobic blocks form the matrix of the film. For example, the multiblock copolymer can have one or two hydrophobic blocks in addition to the hydrogen-bonding block(s). Examples of suitable hydrophobic blocks include poly(styrenes) such as poly(styrene) and poly(alpha-methyl styrene), polyethylene, polypropylene, polyvinyl chloride, poly-tert-butylstyrene, and polytetrafluoroethylene.

In this embodiment, at least one of the additional hydrophobic blocks is a low glass transition temperature (T_{g}) block. By low T_{g} block it is meant that the block has a T_{g} of 25° C. or less. The multiblock copolymer can have multiple low T_{g} blocks. Examples of suitable low T_{g} blocks include poly(isoprene), poly(butadiene), poly(butylene), and poly(isobutylene). In an embodiment, the multiblock copolymer comprises a low T_{g} polymer block, a poly(styrene) block, and a poly((4-vinyl) pyridine) block.

The individual polymer blocks can have a broad molecular weight range. For example, individual blocks having a number averaged molecular weight (Mₙ) of 1×10³ to 1×10⁶ g/mol, including all values to the 10 g/mol and ranges therebetween, are used.

The total molar mass of the multi-block copolymer is such that the multiblock copolymer undergoes self-assembly (i.e., microphase separation). It is desirable that defect-free surfaces are formed upon meso- and macro-porous structure formation. For example, the total molar mass of the multiblock copolymer is from 5×10³ to 5×10⁵ g/mol, including all values to the 10 g/mol and ranges therebetween.

Multiblock copolymers can have a range of polydispersities (M_{w}/Mₙ). For example, the multiblock copolymer can have a polydispersity index (PDI) of 1.0 to 2.0, including all values to the 0.1 and ranges therebetween. It is desirable that the multiblock copolymer have a PDI of 1 to 1.4.

A variety of inorganic nanoparticles can be used. The inorganic nanoparticles are present in the deposition solution at 0.1 percent by weight to 50 percent by weight (the total weight of the solution), including all 0.1 percent by weight values and ranges therebetween. In various embodiments, the deposition solution has 0.1 percent by weight to 5 percent by weight or 10 percent by weight to 25 percent by weight inorganic nanoparticles. There is a correlation between the amount of inorganic nanoparticles in the deposition solutions and the amount of inorganic nanoparticles in the film formed from the deposition solution. In embodiment, substantially all of the inorganic nanoparticles in the deposition solution are in the film formed from the deposition solution. By substantially all the inorganic nanoparticles it is meant that at least 60, 70, 80, 90 percent or 95 percent of the inorganic nanoparticles in the deposition solution are in the film formed from the deposition solution. Generally, lower inorganic nanoparticle loadings in the deposition solution provide a higher percentage of inorganic nanoparticle incorporation in the film. The nanoparticles may be amorphous or crystalline (e.g., have crystalline domains). The nanoparticles are spherical or non-spherical. Examples of inorganic nanoparticles include metal oxide nanoparticles (e.g., doped metal oxide nanoparticles) and metal nanoparticles (e.g., metal alloy nanoparticles having two or more metals). Examples of metal oxide nanoparticles include titanium dioxide, niobium dioxide, and iron oxide nanoparticles. Examples of metal nanoparticles include silver nanoparticles, gold nanoparticles, and platinum nanoparticles. Aluminosilicates nanoparticles (such as silica and transition metal and transition metal oxide nanoparticles) are another example of suitable inorganic nanoparticles. Suitable nanoparticles can be made using methods known in the art (e.g., sol-gel methods) or can be obtained commercially.

It may be desirable that the inorganic nanoparticles have a hydrophilic surface. The nanoparticles may be synthesized such that they have a hydrophilic surface or subject to post-synthesis treatment to provide nanoparticles with a hydrophilic surface. For example, the nanoparticles are a metal oxide (e.g., titanium dioxide) with surface hydroxyl groups providing a hydrophilic surface.

Inorganic nanoparticles having a size of 100 nm or less can be used. For a spherical nanoparticle, the size is the diameter of the nanoparticle. For a non-spherical nanoparticle, the size is the equivalent circular nanoparticle diameter. In an embodiment, the inorganic nanoparticles have a diameter or equivalent circular diameter of 1 nm to 20 nm, including all values to the nm and ranges therebetween. In various embodiments, the inorganic nanoparticles have a diameter or equivalent circular diameter of 1 nm to 5 nm or 1 to 10 nm.

A variety of solvents can be used in the deposition solution. Mixtures of solvents may be used. Examples of suitable solvents include tetrahydrofuran, 1,4-dioxane, morpholine, formylpiperidine, methanol, ethanol, toluene, chloroform, dimethylformamide, acetone, dimethylsulfoxide, dimethylacetamide, N-methylpyrrolidone, and sulfolane.

It may be desirable that the deposition solvent comprises at least 1,4-dioxane. In this case, the deposition solvent may also include an additional solvent or solvents. In various examples, the solvent system is 1,4-dioxane or a mixture of solvents where at least one of the solvents in the mixture is 1,4-dioxane. In various examples, the solvent system has at least 33 percent by weight or at least 50 percent by weight 1,4-dioxane. For example, a solvent system with 70/30 1,4-dioxane/tetrandryofuran by weight can be used. In an embodiment, the solvent comprises 1,4-dioxane. Without intending to be bound by any particular theory, it is considered that use of 1,4-dioxane in the deposition solvent can result in the desired self-assembled morphology of the surface layer of the film upon evaporation. Examples of suitable solvents that can be used in combination with 1,4-dioxane include the aforementioned examples of suitable solvents and combinations thereof.

The concentration of the multiblock copolymer in the deposition solution can be a factor in the structure of the resulting film. The concentration of multiblock copolymer can be selected based on parameters such as the chemical composition and molecular weight of the multiblock copolymer and the deposition solvent(s). The polymer concentration of the casting solution can be, for example, 5 percent by weight to 50 percent by weight, including all integer values of percent by weight and ranges therebetween. Typical concentrations of the multiblock copolymer in the deposition solution can be 8 percent by weight to 20 percent by weight.

The films can be formed without using a metal salt. In an embodiment, the deposition solution does not comprise a metal salt. In an embodiment, the asymmetric organic-inorganic film does not comprise a metal salt.

In an embodiment, the methods can be used to produce asymmetric organic-inorganic nanoparticle films where the films comprise multiblock copolymer and homopolymer and/or small molecules. Such films are blends (e.g., blends of multiblock copolymers with a homopolymer (or homopolymers) and/or small molecules (or mixtures of small molecules). Accordingly, the deposition solution can also include one or more homopolymer and/or one or more small molecule. Examples of suitable homopolymers and small molecules are provided herein.

The multiblock copolymer-inorganic nanoparticle film (which may also contain homopolymers and/or small molecules and may be referred to as an initial film) can be deposited by a variety of methods known in the art. Examples of suitable deposition methods include doctor blade coating, dip coating, flow coating, slot coating, slide coating, inkjet printing, screen printing, gravure (flexographic) printing, spray-coating, and knife coating. For example, when doctor blade coating is used, the gate height can be adjusted to the desired height depending on the concentration of the copolymer in the casting solution. The doctor blade height can be set at, for example, from 50 μm to 500 μm.

At least a portion of the solvents in the solvent system is removed from the film (e.g. initial film) after the film is formed from the deposition solution prior to contacting the film with a phase separation solvent system. For example, from 1 percent by weight to 80 percent by weight, including all integer values of percent by weight and ranges therebetween, of the solvent is removed. The amount of solvent in the film can be measured by techniques known in the art. For example, the amount of solvent in the film can be measured by infrared or UV/vis spectroscopy, or thermogravimetric analysis (TGA).

For example, at least a portion of the solvent(s) in the film is removed by allowing the as deposited film to stand for a period of time. The solvent evaporation is a variable process and can take place over a wide range of times (e.g., from seconds to minutes). The time is dependent on, for example, the deposition solution composition. The solvent removal step can include flowing a gas (e.g., air or nitrogen) or exposing the film to reduced pressure. Such steps can increase the rate of solvent removal.

After the solvent removal step, the film is contacted with a phase separation solvent system. The solvent system can be a single solvent or a mixture of solvents. The solvent system is a non-solvent for the multiblock copolymer (i.e., at least one of the blocks of the multiblock copolymer precipitates in the solvent system). Further, in the case where 1,4-dioxane is used in the deposition solution, 1,4-dioxane must be miscible with the non-solvent. Examples of suitable solvents for use include solvents such as, for example, water, methanol, ethanol, acetone, and combinations thereof.

In an embodiment, the film is contacted with a vapor phase of the phase separation solvent system (i.e., a phase separation solvent system in the vapor phase). The vapor solvent system is a non-solvent for the multiblock copolymer (i.e., at least one of the blocks of the multiblock copolymer precipitates in the solvent system). Examples of suitable solvent vapors for use include solvents such as, for example, water, methanol, ethanol, acetone, and combinations thereof.

Without intending to be bound by any particular theory, it is considered that contacting the film with a non-solvent in either the liquid phase or vapor phase causes at least one of the blocks in the multiblock copolymer to precipitate. The structure of the film is therefore locked in due to vitrification of the polymer.

The films resulting from the method have an identifiable surface layer (also referred to herein as a separation layer) and an identifiable support layer. The surface layer and support layer form a continuous film. The surface layer of the film is away from the substrate and the support layer of the film is disposed on the substrate. The film can be removed from the substrate providing a free-standing film.

The steps of the method described in the various embodiments and examples disclosed herein are sufficient to produce thin films of the present disclosure. Thus, in an embodiment, the method consists essentially of a combination of the steps of the method disclosed herein. In another embodiment, the method consists of such steps.

In an aspect, the present disclosure provides an asymmetric (i.e., the film has a surface layer and a support layer) organic-inorganic film. The film includes at least a multiblock copolymer. The multiblock copolymer can be one of those described herein. The film can be disposed on a substrate or can be a free-standing film.

In an embodiment, the films are graded. By “graded” it is meant that the films have a support layer where the support layer has asymmetric porosity. For example, the pores increase in diameter or equivalent circular diameter through the depth of film moving from the exposed surface of the surface layer through the surface layer and support layer to the substrate or, in the case of a free-standing film, the exposed surface of the support layer. In an embodiment, the support layer is graded. In another embodiment, the surface layer and support layer are graded. Graded asymmetric organic-inorganic film can be made by the methods disclosed herein.

The asymmetric organic-inorganic films can have a variety of shapes. One having skill in the art will appreciate that films having a variety of shapes can be fabricated. The films can have a broad range of sizes (e.g., film thicknesses and film area). For example, the films can have a thickness of 5 microns to 500 microns, including all values to the micron and ranges therebetween. Depending on the application (e.g., bench-top applications, biopharmaceutical applications, and separation applications (e.g., water purification applications), the films can have areas ranging from 10s of cm² to 10s (even 100s) of m².

The asymmetric organic-inorganic films can have desirable properties. For example, the films can have desirable mechanical properties and permeability. The mechanical properties of the films can be tailored by use of selected multiblock copolymers. For example, depending on the multiblock copolymer used and structure of the film, the films can exhibit a hydraulic permeability of at least 1000 L m⁻² hr⁻¹ bar⁻¹.

The structural and performance characteristics of the films can include both stimuli responsive permeation and separation. The films can be tuned in a manner so that transport of various liquids and solids can be controlled. For example, the pore size of the films can be turned (e.g., increased or decreased) by incorporating a homopolymer or a small molecule in the deposition solution or by exposing the film to a specific pH solution (e.g., the film is exposed a feed solution having a desired pH after the formation process).

In an embodiment, the asymmetric organic-inorganic film comprises a multiblock copolymer having at least two blocks that microphase separate, and a plurality of inorganic nanoparticles disposed within at least a portion of the film and on at least a portion of the film surface. In this embodiment, the film has a surface layer having a thickness of 20 nm to 500 nm and a plurality of pores having a diameter of 5 nm to 100 nm in size and a support layer having a thickness of 5 microns to 500 microns and pores having a diameter or equivalent circular diameter of 1 micron to 50 microns.

The asymmetric organic-inorganic film has a surface layer (also referred to herein as a top layer or separation layer) and a support layer. The surface layer can have a range of thicknesses. For example, the surface layer can have a thickness of 20 nm to 500 nm, including all values to the nm and ranges therebetween. The surface layer has a plurality of pores extending thorough the depth of the surface layer. The pores can have morphologies such as cylindrical and gyroid morphologies. The pores can have a size of 5 nm to 100 nm, including all values to the nm and ranges therebetween. For a spherical pore, the size is the diameter of the pore. For a non-spherical pore, the size of the surface layer pore is the equivalent circular diameter of the pore (i.e., the equivalent circular surface layer pore diameter). The surface layer can have a range of pore densities. For example, the surface layer pore density can be from 1×10¹⁴ pores/m² to 1×10¹⁵ pores/m², including all values to the 10 pores/m² and ranges therebetween. In an embodiment, the density of the surface pores of a film as described herein is at least 10¹⁴ pores/m². The surface layer is isoporous. By “isoporous” it is meant that the pores have narrow pore size distribution. For example, a narrow pore size distribution (defined as the ratio of the maximum pore diameter to the minimum pore diameter (dₘₐₓ/dₘᵢₙ)) can be from 1 to 3, including all values to 0.1 and ranges therebetween. In various examples, (dₘₐₓ/dₘᵢₙ) is 1, 1.5, 2, 2.5, or 3. For example, the film comprises a surface layer having nearly monodisperse mesopores. In an embodiment, the isoporous surface layer has a pore density of at least 1×10¹⁴ pores/m² and a pore size distribution (dₘₐₓ/dₘᵢₙ) of less than 3. The pores in the surface layer are interconnected. In an embodiment, the pores in the surface layer form an interconnected network.

Without intending to be bound by any particular theory, it is considered that the morphology of the surface layer is, in part, a result of the self-assembly of the block copolymer. The morphology of this layer is dependent on the casting conditions (e.g., flow rate of environment around the film, water (humidity)/solvent concentration in environment around the film, evaporation time, casting speed, gate height) as well as the composition of the casting solvent (e.g., polymer molecular weight, chemistry, concentration, casting solvent or mixture of solvents).

The support layer is disposed between the surface layer and the substrate in cases where the film is disposed on the substrate. This layer is a supporting sub-structure layer. The support layer can have a range of thicknesses. For example, the thickness of the support layer can be from 5 microns to 500 microns, including all values to the micron and ranges therebetween. The pores in the support layer can be from 10 nm to 100 microns in size, including all values to the nm and ranges therebetween. For a spherical support layer pore, the size is the diameter of the pore. For a non-spherical support layer pore, the size is the equivalent circular diameter of the pore (i.e., the equivalent circular support layer pore diameter). The pores in the support layer are interconnected. In an embodiment, the pores in the support layer form an interconnected network. In an embodiment, the pores in the surface layer and support layer are interconnected and form a continuous network.

The support layer may have a graded structure. In this case, moving from the top of this layer (e.g., the surface in contact with the surface layer) to the bottom of the layer (e.g., the free surface or surface in contact with the substrate), the pores increase in size. For example, the support layer can have pores having a size of 10 nm at the top of the support layer (layer in contact with the surface layer) and the pores increase in size to 100 μm at the bottom of the support layer. The increase in pore size moving though the depth of the film (e.g., from the surface of the support film in contact with the surface layer to the surface of the film in contact with the substrate) provides an asymmetric structure. This support layer may be formed as a result of contacting (e.g., immersing) the film into a non-solvent bath.

The amount of inorganic nanoparticles in the deposition solution can provide films with different support layer structure (e.g., different pore morphology). Based on the amount of inorganic nanoparticles in the deposition, the resulting film can have, for example, “sponge-like” morphology or “finger-like” morphology. For example, in some cases, use of a deposition solution with less than 3 percent by weight inorganic nanoparticles provides films with a “sponge-like” morphology. In another example, in some cases, use of a deposition solution with 3 percent by weight or greater inorganic nanoparticles provides films with a “finger-like” morphology.

In an embodiment, the support layer has a “sponge-like” structure. The pores in the “sponge-like” structure have diameter or equivalent circular support layer pore diameter of 10 nm to 5,000 nm, including all integer nm values and ranges therebetween, and have an aspect ratio of less than 2. In this embodiment, the pores may be graded.

In an embodiment, the support layer has a “finger-like” structure. The pores in the “finger-like” structure have a diameter or equivalent circular support layer pore diameter of 1,000 nm to 500,000 nm, including all integer nm values and ranges therebetween, and have an aspect ratio of 2 or more. For example, in the “finger-like” structure embodiment, a plurality of the pores in the support layer lie on a plane that is 20 microns from the surface layer and substantially parallel to the surface-layer-support-layer interface of the film have a diameter or equivalent circular support layer pore diameter in the plane (i.e., cross-sectional diameter or equivalent circular support layer pore diameter) of at least 5 microns. By “substantially” it is meant that the angle formed by the cross-sectional diameter or equivalent circular support layer pore diameter dimension of the pores and surface-layer-support-layer interface is +/−10 degrees from 90 degrees. In various embodiments, that the angle formed by the cross-sectional diameter or equivalent circular support layer pore diameter dimension of the pores and surface-layer-support-layer interface is +/−5 degrees, 4 degrees, 3 degrees, 2 degrees, or 1 degree from 90 degrees. In various embodiments, a plurality of the pores in the support layer lying on a plane 5, 10, or 40 microns from the surface layer and parallel to the surface-layer-support-layer interface of the film have a diameter or equivalent circular support layer pore diameter in the plane of at least 1, 2.5, or 10 microns, respectively. In this embodiment, the pores may be graded.

In another example, in “finger-like” structure embodiment, at least a portion of the pores in the support layer have an aspect ratio of greater than 2. “Aspect ratio” as used herein means the ratio of length of the pore along the axis perpendicular to the surface-layer-support layer interface to the longest length of a cross-section of the pore parallel to the surface-layer-support layer interface. In various embodiments, at least a portion of the pores in the support layer have an aspect ratio of greater than 3, greater than 4, or greater than 5.

The support layer has a hierarchical structure. What is meant by hierarchical is that the pores in the support layer are mesoporous. In an embodiment, at least a portion of the pore surface (e.g., pore walls) is mesoporous. For example, at least a portion of the pore surface (e.g., pore walls) in the support layer has pores with a diameter or equivalent circular diameter of 2 nm to 50 nm, including all integer nm values and ranges therebetween.

The film has inorganic nanoparticles disposed within and on the surface of the film. For example, the inorganic nanoparticles are present in the polymer matrix of the film (e.g., throughout the separation and support layers) and on the surface of the film (including the pore surface). Some portion of the nanoparticles is present within the film (i.e., completely encapsulated by the polymer matrix of the film) and some portion of the nanoparticles is present on the surface. In an embodiment, the inorganic nanoparticles are not present solely on a surface of the film. The film has 0.1 percent by weight to 50 percent by weight, including all integer percent by weight values and ranges therebetween, inorganic nanoparticles. In various embodiments, the film has 0.1 percent by weight to 5 percent by weight or 10 percent by weight to 25 percent by weight inorganic nanoparticles.

The asymmetric organic-inorganic film may have a homopolymer and/or small molecule additive. In an embodiment, the film further comprises homopolymer and/or small molecules. The homopolymer and/or small molecule is blended in the multiblock copolymer. For example, the homopolymer and/or small molecule is blended in (i.e., mixed with) the hydrogen-bonding block or hydrophobic block of the multiblock copolymer. The homopolymer and/or small molecule may preferentially associate with one of the blocks of the multiblock copolymer and locate in the vicinity of that block. For example, poly(phenylene oxide) can mix with a poly(styrene) block of a multiblock copolymer. For example, poly(butadiene) can mix with a poly(isoprene) block of a multiblock copolymer. Such films can be prepared as described herein.

A variety of homopolymers can be used. For example, any homopolymer that has the same chemical composition as or can hydrogen bond to at least one block (e.g., the hydrogen-bonding block) of the multiblock copolymer can be used. By same chemical composition it is meant that in an A-B type diblock copolymer the homopolymer is chemically composed of A (or B). The homopolymer may have hydrogen bond donors or hydrogen bond acceptors. Examples of suitable homopolymers include poly((4-vinyl)pyridine), poly(acrylic acid), and poly(hydroxy styrene). In cases where the multiblock copolymer has a hydrogen-bonding block, it is desirable that the homopolymers or small molecules have a low or negative chi parameter with the hydrogen-bonding block (e.g., poly((4-vinyl)pyridine)). A range of ratios of multiblock copolymer to homopolymer can be used. For example, the molar ratio of multiblock copolymer to homopolymer can be from 1:0.05 to 1:10, including all ranges therebetween. The homopolymer can have a range of molecular weight. For example, the homopolymer can have a molecular weight of 5×10² g/mol to 5×10⁴ g/mol.

A variety of small molecules can be used. For example, any small molecule that can hydrogen bond to at least one block of the multiblock copolymer can be used. The small molecule can have hydrogen bond donors or hydrogen bond acceptors. Examples of suitable small molecules include pentadecyl phenol, dodecyl phenol, 2-4′-(hydroxybenzeneazo)benzoic acid (HABA), 1,8-naphthalene-dimethanol, 3-hydroxy-2-naphthoic acid, and 6-hydroxy-2-naphthoic acid. A range of ratios of multiblock copolymer to small molecule can be used. For example, the molar ratio of multiblock copolymer to small molecule can be from 1:1 to 1:1000, including all integer ratios therebetween.

In an embodiment, the film further comprises an inorganic material disposed on at least a portion of a surface of the film. This inorganic material is the same or different than the aforementioned inorganic nanoparticles. This inorganic material is added to the film after the film is formed (i.e., it is post-film formation inorganic material). The inorganic material is disposed on at least a portion of the film (e.g., the top, self-assembled surface layer surface, pore surface of the surface layer, and pore surface of the graded substructure). For example, the inorganic material can be in the form of nanoparticles. The nanoparticles can be, for example, 1 to 200 nm, including all values to the nanometer and ranges therebetween, in diameter. Examples of suitable inorganic materials include metals, metal oxides (e.g., silver oxide and copper oxide) and semiconductors (e.g., semiconducting nanoparticles such as CdS nanoparticles). For example, the film further comprises a plurality of metal nanoparticles. The metal nanoparticles inorganic are disposed on at least a portion of the film (e.g., the top, self-assembled surface layer surface, pore surface of the surface layer, and pore surface of the graded substructure). The nanoparticles can complex (e.g., through weak intramolecular forces) with the multiblock copolymer of the film surface or form on the original inorganic nanoparticles from the deposition solution. The nanoparticles can be, for example, 1 to 200 nm, including all values to the nanometer and ranges therebetween, in diameter. Examples of suitable metals for the metal nanoparticles include gold, silver, platinum, palladium, cobalt, copper, nickel, iron, zinc, chromium, ruthenium, titanium, zirconium, molybdenum, aluminum, and cadmium. The nanoparticles can be mixtures of different nanoparticles. Films with silver nanoparticles can exhibit antimicrobial behavior. For example, the inorganic material can be disposed on at least 50 percent, at least 60 percent, at least 70 percent, at least 80 percent, at least 90 percent, at least 95 percent, at least 99 percent of the surfaces of the film. In an example, the inorganic material is disposed on 100 percent of the surfaces of the film.

The inorganic materials can be deposited on the film by methods known in the art. For example, the inorganic material can be deposited by electroless deposition methods.

In an aspect, the present disclosure provides uses of the films of the present disclosure. The films can be used in applications such as, for example, filtration applications (e.g., chemical/biological molecule separations, and water purification), drug delivery, and molecular sensing.

Examples of filtration applications include concentration or purification of therapeutic proteins or other macromolecules, removal of water contaminants, and use as an air filter. For example, the films can be used as filtration media in filtration devices (e.g., ultrafiltration devices) for concentration and/or purification or proteins, viruses, or other dissolved material, and as a separation media for liquids, vapors (i.e., gas), or solutions. Pressure may be applied across the films (e.g., parallel or perpendicular to the film surface by pressurized air or centrifugal force) to facilitate flow of feed streams across or through the film. The films can also be used as a penetrable catalyst support substrate.

In an embodiment, a method of filtration comprises contacting a film of the present disclosure with a mixture (e.g., a feed stream) comprising at least one material (e.g., nanoparticles, biological materials such as, for example, cellular debris, proteins, nucleic acids, and viruses) that is to be separated from the mixture under conditions such that the at least one material is separated from the mixture. In an embodiment, pressure is applied across or through the film. In an embodiment, the mixture comprises a protein and a virus and the protein is separated from the virus.

In an aspect, the present disclosure provides devices comprising a film of the present disclosure. For example, the films can be used as filtration membranes in filtration devices (e.g., ultrafiltration devices) for concentration and/or purification or proteins, viruses, or other dissolved material, and as a separation media for liquids, vapors (i.e., gas), or solutions. The films may be used in normal flow or tangential or cross-flow configurations. The films may be encapsulated in housings to form devices. The housings are comprised of, for example, polypropylene or metal. Examples of the devices are known in the art and the devices can be made using methods known in the art.

The multiblock copolymers offer a functional approach for designing a versatile assortment of mesoscale materials, such as patterned media, and devices, including batteries, solar cells, and fuel cells. In addition to applications in drug delivery and nanofluidics, the asymmetric multiblock copolymer films can be used as separation media.

The following examples are presented to illustrate the present disclosure. They are not intended to be limiting in any manner.

### Example 1

This example provides a description of preparation, characterization, and use of examples of films of the present disclosure.

A facile method for forming asymmetric organic-inorganic membranes for selective separation applications was developed. This approach combines co-assembly of block copolymer (BCP) and inorganic nanoparticles (NPs) with non-solvent induced phase separation. The method was successfully applied to molar mass BCPs with different fractions of titanium dioxide (TiO₂) NPs. Two examples of BCPs used are, ICV43 and ICV91, although other BCP can be used as well. The resulting hybrid membranes exhibited structural asymmetry with a thin nanoporous surface layer on top of a macroporous finger-like support layer. Parameters that dictated membrane surface morphology include the fraction of inorganics used and the length of time allowed for surface layer development. In filtration test, the resulting membranes show both desirable selectivity and permeability (3200 [symbol] 500 Lm⁻²h⁻¹bar⁻¹). This facile and straightforward synthesis method for asymmetric hybrid membranes provides a new self-assembly platform upon which multi-functional and high-performance organic-inorganic membranes can be formed.

A strategy for improving the functionality of organic membranes is through the incorporation of inorganic nanoparticles (NPs) to produce hybrid organic-inorganic membranes. The resulting organic-inorganic membranes combine the properties of the inorganics, such as mechanical and thermal stability, chemical activity and pressure resistivity, with the flexibility and processability of organic materials. An example of an inorganic additive is titanium dioxide (TiO₂). In addition to high hydrophilicity and chemical stability, polymer-TiO₂ hybrid membranes have been shown to exhibit photochemical reactivity and antimicrobial behavior, which may open the door to next-generation functional antifouling and “self-cleaning” membranes.

Block copolymer (BCP) self-assembly is a method for achieving well-ordered, periodic structures on length scales of ˜5-50 nm. A method for translating the periodic, uniform structures possible with BCPs to high performance membranes combines BCP self-assembly and non-solvent induced phase separation, abbreviated as SNIPS. This simple and fast method involves dissolving a BCP in a specific solvent system, which is then cast onto a substrate under controlled gate height; the film is allowed to evaporate for a short time (usually tens of seconds) before immersing into a coagulation bath. The SNIPS procedure resulted in a graded membrane composed of a uniformly nanoporous surface (separation layer) above a macroporous support layer. The SNIPS process of generating asymmetric BCP membranes achieved relatively high selectivities due to the uniform pore size from self-assembly. Inorganic components were added into the formation process itself, rather than via post-processing steps as has been previously done.

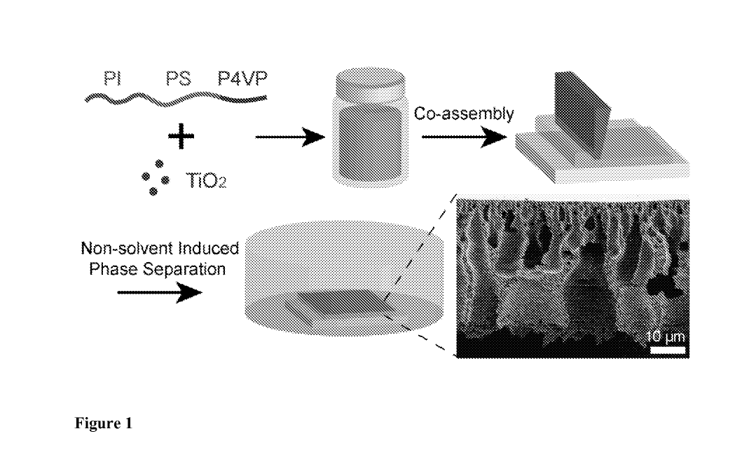

The fabrication of an asymmetric organic-inorganic hybrid membrane was demonstrated by marrying BCP and inorganic NP co-assembly and non-solvent induced phase separation, referred to in the following as CNIPS. It is a facile “one-pot” type process incorporating inorganics at significant weight fractions in the final membrane and should thus be amenable to large scale membrane fabrication. This method achieved a significant inorganic content in the final membrane. The BCP used for hybrid membrane fabrication was the triblock terpolymer poly(isoprene-b-styrene-b-4-vinylpyridine) (ISV) with volume fractions of 0.30, 0.55 and 0.15 for polyisoprene (PI), polystyrene (PS) and poly(4-vinylpyridine) (P4VP) blocks, respectively. Two ISVs with similar chemical composition but different total molar masses of 43 kg/mol and 91 kg/mol, abbreviated as ISV43 and ISV91, were synthesized by anionic polymerization. Details of the polymer characterization of the ISVs can be found in Table 2 in Example 2. Scheme 1 in FIG. 1 shows the fabrication procedure of the organic-inorganic hybrid membranes. ISV was first dissolved in a solvent mixture of tetrahydrofuran (THF) and 1,4-dioxane (DOX). A hydrolytic sol-gel route was used to prepare TiO₂ sol NPs by hydrolysis of TiO₂ precursors (titanium tetraisopropoxide, TTIP) in an aqueous environment. Different amounts of TiO₂ sol solution were subsequently added into the ISV solution and stirred for three hours to form the casting solutions. Due to preferential interactions, TiO₂ sol NPs are expected to selectively incorporate into the P4VP block. The final casting solution had a THF/DOX weight ratio of about 3/7 and the ISV/solvent weight ratio of either about 0.07 or about 0.09. The casting solution was then hand cast into a film by a doctor blade onto a clean glass substrate. The gate height of the doctor blade was kept at 220 μm. The film was allowed to evaporate for a certain time (30 sec 90 sec), during which the increased surface concentration drove ISV-TiO₂ co-assembly. Then the film was immersed into a coagulation bath of deionized water, which is miscible with both solvents but precipitates the ISV. This non-solvent induced phase separation (NIPS) (or phase inversion) process solidifies the polymer film through exchange of solvent and non-solvent (water) and forms the asymmetric membrane. Meanwhile the self-assembled top structure is kinetically trapped due to the rapid precipitation of the surface polymer once the film is plunged into water.

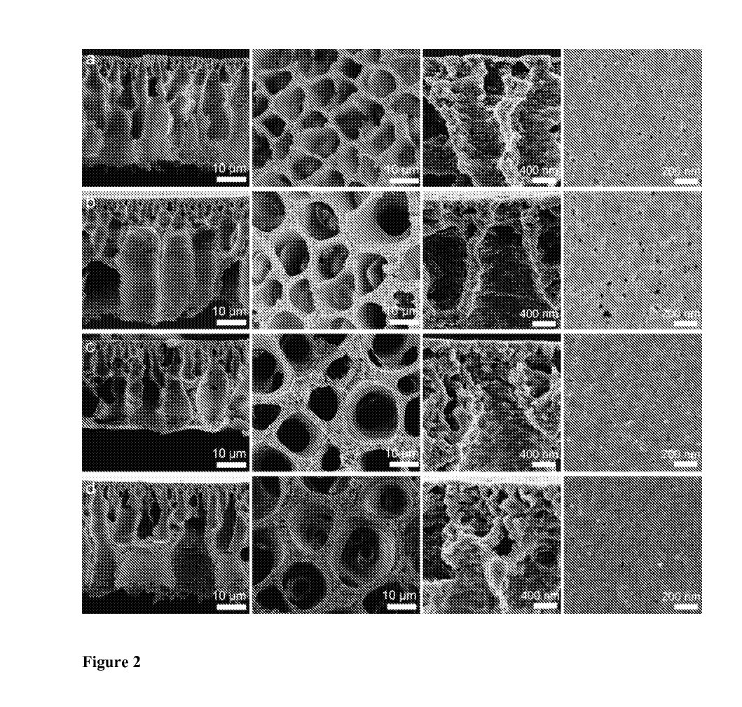

FIG. 2 shows scanning electron microscope (SEM) images of dried hybrid membranes from ISV43 with 11 wt % TiO₂ (i.e. mass of TiO₂ introduced in the casting solution over the total mass of ISV and TiO₂). The inorganic content in the casting solution was found to be consistent with thermogravimetric analysis (TGA) of the dried hybrid membrane (FIG. 7), suggesting that for this weight fraction of inorganic in this polymer, all of the TiO₂ is incorporated into the final membrane. Membranes in FIGS. 2(a), (b) and (c) were cast from the 0.07 ISV weight ratio solution, with 11 wt % TiO₂ and allowed to evaporate for 30 sec, 45 sec, and 60 sec, respectively, before immersion into water. Membrane in FIG. 2(d) was cast from the 0.09 ISV weight ratio solution with 11 wt % TiO₂ at 30 sec evaporation time. The left column compares cross-sectional SEM images of the corresponding hybrid membranes. These membranes all exhibited dense top surface structures and a gradual increase in the pore size to a finger-like macroporous support structure. Shown in the second column are views of the bottom surface of the membranes, which were formerly in contact with the glass substrate. These images demonstrate that the bottom surfaces all exhibited open pores with diameters in the range of 10-30 μm. The third column depicts higher magnification cross-sections near the top surface, revealing a dense separation layer˜100 nm thick. Images in the last column suggest that the top surfaces of these membranes have open pores with diameters˜20-30 nm.

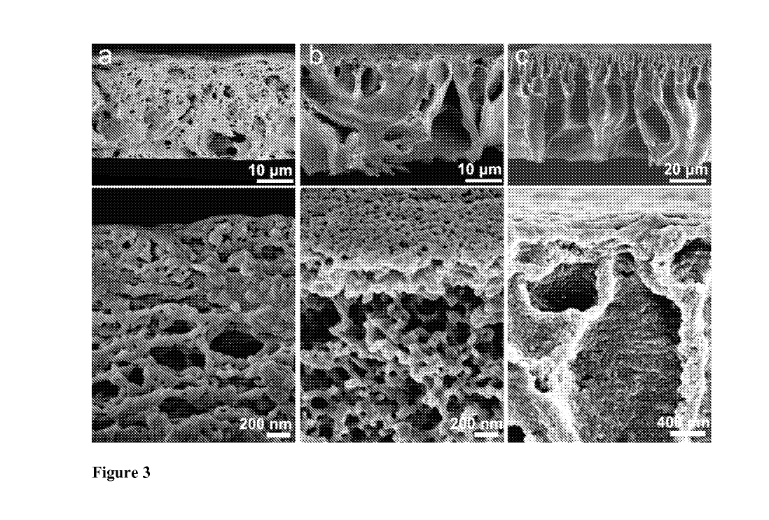

FIG. 3 shows a comparison of (a) the purely organic ISV91 membrane (without TiO₂) and (b, c) two ISV91-TiO₂ organic-inorganic hybrid membranes cast from solutions with different inorganic loadings (3 wt % and 26 wt %). All the membranes were cast from a 0.07 ISV91 weight ratio solution and evaporated for 45 sec. In both the organic and hybrid membrane, the top surfaces are dense compared to the bottom and have mesoscale structural features, as shown in the higher magnification SEM images at the bottom, giving rise to the asymmetry in the cross-section. However, a distinct morphological transition from sponge-like to finger-like occurs in the support structure upon the introduction of increasing amounts of inorganics. Both sponge-like and finger-like macroporous morphologies are commonly seen in phase inversion membranes. Different models for the phase inversion process were proposed and the mechanisms for forming sponge-like or finger-like macrovoids are still under discussion. Generally, changes in membrane casting conditions and formation chemistry that increase the rate of demixing or polymer precipitation result in a membrane with finger-like morphology. This suggests that the introduction of TiO₂ sol NPs in the process increases the rate of polymer precipitation relative to the purely organic system. Through the hydrolytic sol-gel process there exist Ti—OH groups on the surface of the TiO₂ sol NPs. These hydrophilic surface groups may facilitate the exchange rate of solvent and non-solvent, increasing the demixing rate of ISV.

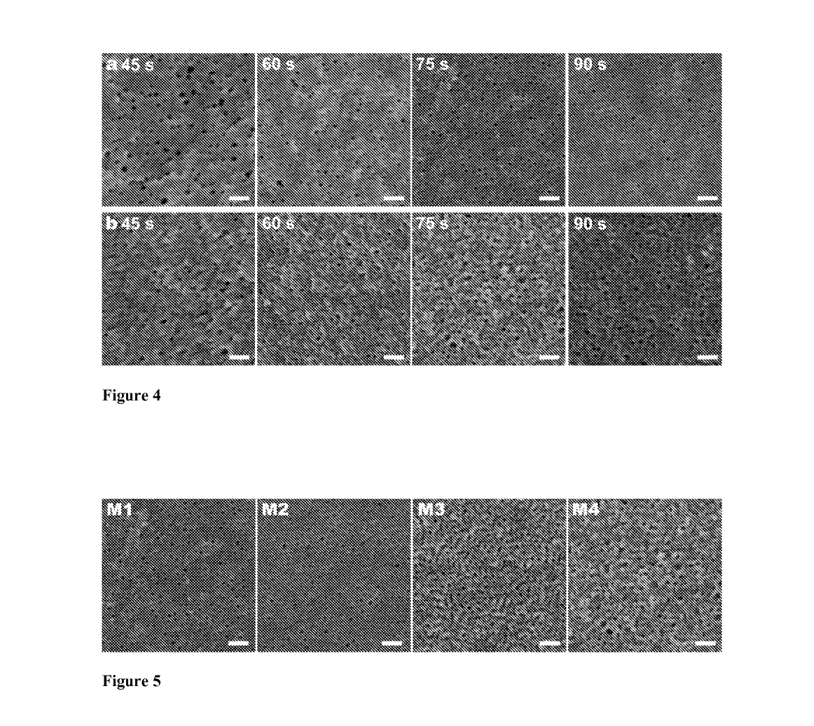

The solvent evaporation step is critical in directing BCP self-assembly, in particular in the surface layer where the concentration of polymer is highest after certain evaporation time. This step was evaluated by varying the solvent evaporation time of films before immersion, under otherwise identical casting conditions. The top surfaces of the resulting membranes are shown in FIG. 4. The precipitation of polymer at the casting solution—nonsolvent interface where the solvent—non-solvent exchange is the most rapid, occurs almost immediately upon plunging the film into the coagulation bath. Thus the top surface of the hybrid membrane directly reflects the kinetically trapped structure from self-assembly of ISV and TiO₂ sol NPs. FIG. 4 (a) shows SEM images of membranes cast from a 0.07 ISV91 solution with 3 wt % TiO₂ and FIG. 4 (b) shows membranes cast from a 0.07 ISV91 solution with 21 wt % TiO₂. At 45 sec, both inorganic loadings resulted in membranes with a porous top surface structure with relatively heterogeneous pore sizes. The pore sizes appear more homogeneous as evaporation time increases, and optimal pore size distribution and homogeneity occurred at 75 sec. At both 3 wt % and 21 wt % TiO₂, more than 90 sec of evaporation resulted in nearly dry films; and limited phase separation was observed after immersing the films into water leading to limited porosity of the surface separation layer. For this reason, further evaporation times were not examined Overall, SEM analysis revealed that varying the inorganic loading resulted in different surface morphologies, indicating that the TiO₂ loading is an important factor in determining separation layer structure.

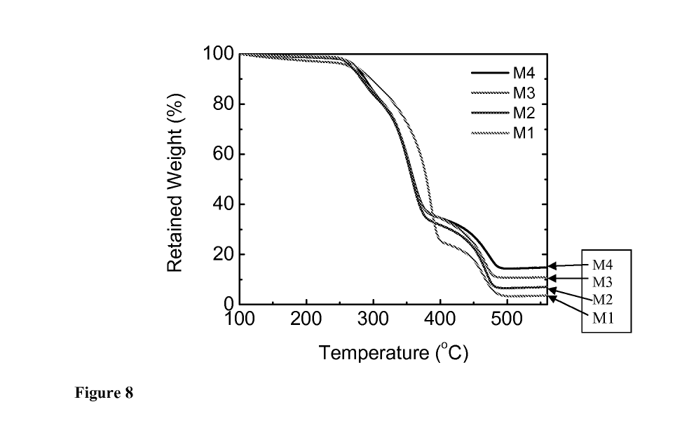

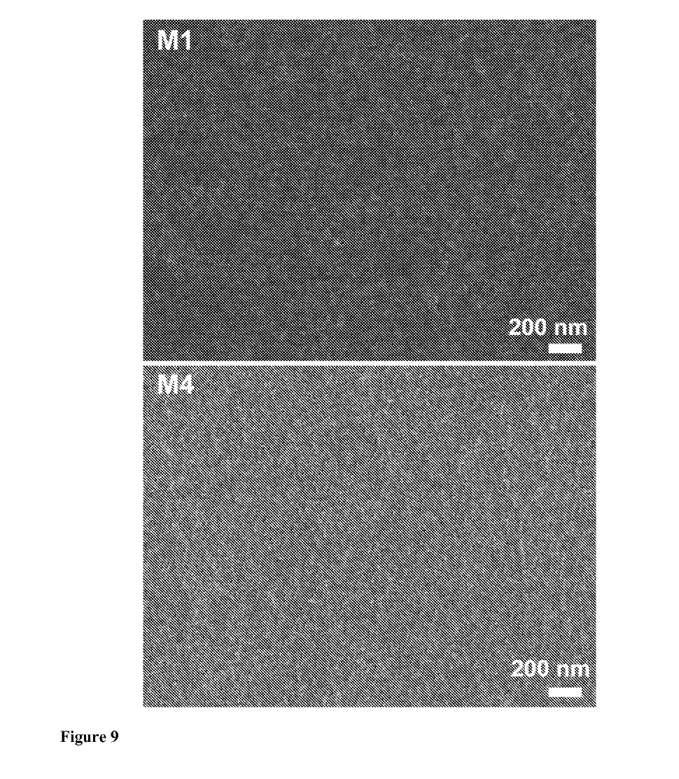

To further understand the relationship between surface morphology and inorganic loading, four membranes with inorganic fractions of 3 wt % (M1), 8 wt % (M2), 15 wt % (M3) and 21 wt % (M4) in total mass of ISV and TiO₂ were prepared from 0.07 ISV91 solution and evaporated for 75 sec. SEM surface images of the resulting membranes are shown in FIG. 5 (M1 and M4 are duplicated from FIG. 4 for comparison). These hybrid membranes exhibited a defect-free surface over relatively large areas (at least 25 μm² shown in FIG. 9) and the pore sizes were nearly monodisperse. The increase in inorganic content in the casting solution is also reflected in TGA measurements, indicating inorganic contents of 3 wt %, 7 wt %, 11 wt %, and 15 wt % for the final membranes (FIG. 8). Thus, even for loadings as high as 21 wt % in the casting solution, more than 70% of the inorganics are retained in the final dried membrane after co-assembly and immersion into water. Analysis of the SEM images of M1 indicates a top surface pore density of more than 10¹⁴ pores/m². Large pore densities in the separation layer can result in high permeability, while small pore size distributions can lead to high selectivity, two critical performance metrics in membrane-based separations. The images in FIG. 4 further suggest that by increasing the inorganic loading, the surface morphologies of the hybrid membranes change from a relatively flat surface with straight circular pores to a surface with tortuous pores from a continuous network-like matrix structure. This morphological tortuosity transition is indicative of swelling of the P4VP domains by the TiO₂ sol NPs.

Using a dead-end pressurized stirred cell, the DI water flux was determined for the hybrid membrane M4. Results are shown in FIG. 5 (a). A detailed description of the membrane performance test can be found in the Supporting Information. The measured flux through the membrane depended linearly on the applied trans-membrane pressure, as expected for a stable porous membrane. Four separate M4 membranes were tested in a pressure range of 0.01-0.03 bar and yielded an average permeability of 3200 [symbol] 500 Lm⁻²h⁻¹bar⁻¹ for DI water. Compared with the permeability (˜150 Lm⁻²h⁻¹bar⁻¹) observed for a purely organic membrane cast from a ISV with similar molecular characteristics employing the SNIPS method (membrane cast from 12 wt % ISV59 in the same solvent mixture, with the same gate height and evaporation time), the permeability of the hybrid membrane is one order of magnitude higher. The high permeability in these organic-inorganic membranes is very promising for effective separation applications.

The Hagen-Poiseuille equation, which can be used to relate permeability with membrane structure, was used to estimate permeability of the M4 membranes. Because SEM images of M4 suggest that the separation layer pores are not perfect cylinders with a tortuosity of 1, but instead exhibit a network-like structure; the calculation assumed a tortuosity of 1.8, which is based on previous work. The analysis using the Hagen-Poiseuille equation as detailed in Example 2 suggests that CNIPS membranes without a macroporous support structure can achieve permeabilities up to several thousand Lm⁻²h⁻¹bar⁻¹. This indicates that the finger-like support structure of the organic-inorganic membranes tested here minimally obstructs the separation layer and does not significantly contribute to flow resistance. In contrast, the sponge-like support structure in organic ISV membranes increases hydraulic resistance, possibly due to separation layer pore blocking and increased overall tortuosity, ultimately lowering the permeability. Furthermore, decreasing the separation layer thickness, as recently reported for SNIPS membranes, leads to an increase in the permeability. Achieving the very high permeability in the CNIPS membrane is thus likely due in part to the highly porous finger-like substructure supporting the separation layer, as well as the relatively thin separation layer.

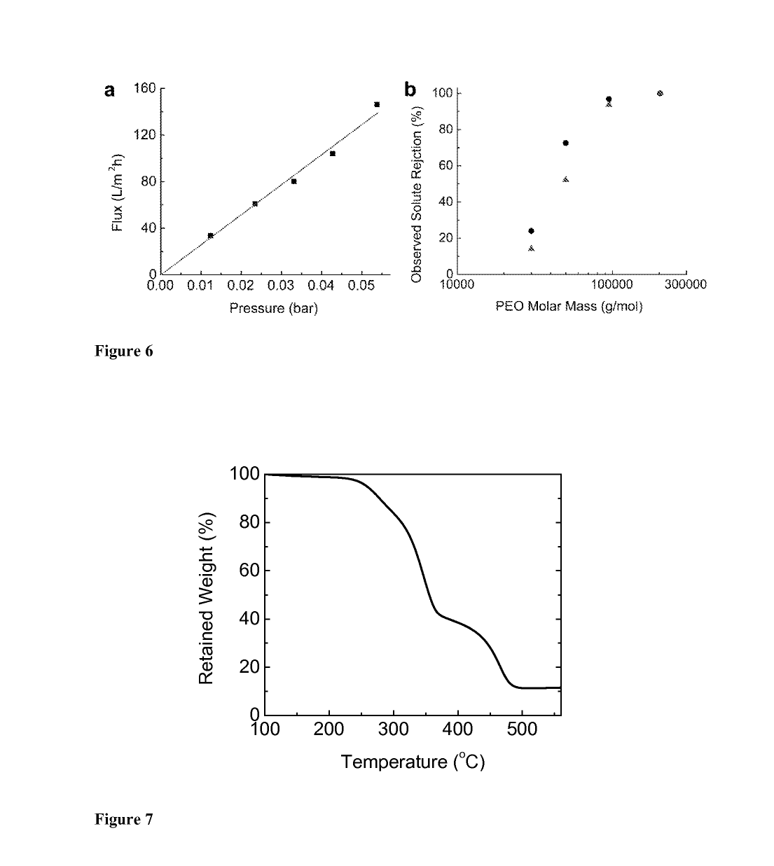

The organic-inorganic membranes cast from 0.07 ISV91 solutions with 21 wt % TiO₂, at 75 sec evaporation time (M4) were also challenged with dissolved solutes to evaluate rejection characteristics using aqueous solutions of 1 g/L poly(ethylene oxide) (PEO) of different molar masses (30, 50, 95 and 203 kg/mol). Solute rejection data for two CNIPS membranes fabricated under the same conditions are shown in FIG. 6 (b). Since the solution flux is relatively high through the membrane, low pressures and high stir rates were chosen to minimize the concentration polarization effect. For all the solute rejection data points, the ratios of solvent flux (Jᵥ) to average mass transfer coefficient were within 0.4-0.9, indicating minor concentration polarization effects. Both membranes rejected 100% of the 203 kg/mol PEO solution, verifying the absence of cracks (defects). Lowering the molar mass of PEO resulted in a decreased rejection. The molecular weight cut-off (MWCO) (at 90% rejection) of these membranes was ˜90 kg/mol PEO.

The mechanical sieving model developed by Zeman and Wales can be used to relate the pore size of the membrane to the actual solute rejection, which can be obtained from the observed solute rejection data by correcting for concentration polarization. The formula for the mechanical sieving model is shown below:

R=1−(1−λ)²[2−(1−λ)²]exp(−0.7146λ²)

Here λ, is the sieving coefficient, which is the ratio of solute size to pore size (rₛₒₗᵤₜₑ/rₚₒᵣₑ). The hydrodynamic radius of PEO is used to represent the solute size which can be estimated from either tracer diffusion or intrinsic viscosity. rₚₒᵣₑ can be adjusted to fit the MWCO curve to the mechanical sieving model. The calculated pore diameters (dₚₒᵣₑ=2rₚₒᵣₑ) from diffusion and intrinsic viscosity data are shown in Table 1. The pore sizes calculated from this model are consistent with the pore size shown in the SEM micrographs of M4. A structure factor (δₘ/ε), which relates the effective path length to the porosity (void fraction), was derived using the Hagen-Poiseuille equation and found to be 2.5 μm. Structure factors of 0.69 μm based on SEM separation layer characterization, 6.4 μm based on a convection-diffusion-affinity model, and 8.6 μm based on the mechanical sieving model were previously estimated for organic SNIPS membranes derived from a 59 kg/mol ISV. With respect to the convection-diffusion affinity and mechanical sieving model calculations, the structure factor for the CNIPS membranes described here is expectedly lower due to their significantly higher permeabilities. Relative to the calculation based on SEM separation layer characterization, the CNIPS membrane structure factor is larger, likely due to the decreased pore density.

TABLE 1
Calculated pore diameters from diffusion and intrinsic viscosity data

| | dₚₒᵣₑ, using diffusion data | dₚₒᵣₑ, using viscosity data |
|---|---|---|
| M4-1 | 21 nm | 29 nm |
| M4-2 | 22 nm | 31 nm |

A new method utilizing BCP-TiO₂ co-assembly and non-solvent induced phase separation, referred to as CNIPS, was developed. The resulting BCP-TiO₂ organic-inorganic hybrid membranes have a dense layer with mesoscale pores of homogeneous sizes above a finger-like macroporous support structure. The ultrahigh permeabilities and sharp MWCO curves observed for CNIPS membranes demonstrate their capacity for excellent performance in separation applications. Furthermore, the incorporation of significant amounts of inorganic material expands the functional potential of self-assembled membranes. This facile “one-pot” synthesis method eliminates the need for post treatment steps and allows for the design of multi-functional asymmetric organic-inorganic hybrid membranes.

### Example 2

This example provides examples of synthesis of copolymers used in the present disclosure and preparation and characterization of films of the copolymers.

ISV synthesis and characterization. The ISVs were synthesized using living anionic polymerization following the procedures described in the literature. The molar masses and polydispersities of the ISVs was determined using Waters 510 gel permeation chromatography (GPC) with a differential refractive index (RI) detector. The volume fraction of each block was calculated from NMR data obtained using a Varian INOVA 400 MHz ¹H solution nuclear magnetic resonance (¹H NMR) spectrometer with CDCl₃ (δ=7.27 ppm) signal as an internal standard.

TABLE 2
Volume fractions (f), molar masses (Mₙ), and polydispersities (PDI)
of the two ISV triblock terpolymers used in this example.

| | | | | Mₙ | |
|---|---|---|---|---|---|
| | f_{PI} | f_{PS} | f_{P4VP} | (kg/mol) | PDI |
| ISV43 | 0.27 | 0.55 | 0.18 | 43 | 1.02 |
| ISV91 | 0.32 | 0.55 | 0.13 | 91 | 1.20 |

ISV43 and ISV91 are two block copolymers that have been used in the synthesis of these membranes. Other block copolymers of different Mₙ and composition can also be used.

Procedure for TiO₂ sol solution preparation. TiO₂ sol NPs were prepared by quickly adding through a septum 1.0 mL titanium tetraisopropoxide (97%, Sigma-Aldrich) into 0.312 mL HCl (37 wt %, Sigma-Aldrich) in a closed vial under vigorous stirring. The vial was kept closed and under stirring for 5 min before adding 3.0 mL anhydrous tetrahydrofuran (Sigma-Aldrich). After stirring this solution for 2 min, different amounts of sol solution were added to the ISV solutions. TiO₂ concentration was estimated to be 0.76 mol/L in the sol solution, assuming a full conversion of TiO₂ precursor, and based on the volume of the solution after THF dilution.

Inorganic content in final membranes by TGA. Membranes were carefully transferred from the DI water bath and dried in air. A T.A. Instruments Q500 Thermogravimetric Analyzer (TGA) was used to analyze the retained inorganic content in the dried membranes. The TGA was under air atmosphere with a ramp rate of 10° C./min from room temperature to 560° C.

SEM sample preparation and low-magnification SEM micrographs of membranes SEM micrographs were acquired using a LEO 1550 ultrahigh resolution analytical field emission scanning electron microscope (FE-SEM) equipped with an in-lens detector. Samples were coated with Au—Pd for 10 sec prior to imaging using a Denton Vacuum Desk II sputter coater.

Membrane performance tests A stirred dead-end ultrafiltration test cell (Amicon 8010, Millipore, effective area 4.1 cm²) was used in the water flux and solute rejection test. The cell was connected to a N₂ gas inlet and the pressure was monitored by an upstream digital gauge. The water (solute) height in the cell was kept constant for each test. During the test, the volume of solution transferred across the membrane was <10% of the total feed volume. The pressure resulting from the water (solute) mass was 0.03 psi and was added to the N₂ pressure shown on the gauge. For membrane performance experiments, ˜1 mL of permeate was collected in a clean vial on a digital balance with the mass data collected by a computer every 5-12 sec. Pressure varied by [symbol] 0.01 psi over a given experiment.

The permeability of DI water in an ultrafiltration process was calculated from equation (1) shown below:

Lₚ=Jᵥ/ΔP (1)

where Jᵥ is the volumetric filtrate flux (volume flow rate per membrane area with the unit of m/s or Lm⁻²h⁻¹) and ΔP is the trans-membrane pressure driving force.

PEO (Polymer Source Inc., Montreal, Quebec, Canada) solutions were all prepared at a concentration of 1 g/L in DI water. The tests are conducted in a similar way as describe in the literature. The PEO concentration in the feed and permeate was determined by an aqueous GPC (Waters Ambient Temperature) with a Waters 410 differential RI detector. The observed solute rejection was calculated from equation (2) as follows:

R=1−Cₚ/C_{f} (2)

Where Cₚ and C_{f} are the concentration of solute in the permeate and feed, respectively.

Permeability analysis from the Hagen-Poiseuille equation. The Hagen-Poiseuille equation relates membrane permeability (Lₚ) with volumetric flux (Jᵥ) and transmembrane pressure (zip) to the membrane structure parameters as

$${L}_{p} = \frac{{J}_{v}}{Δ p} = \frac{ɛ \cdot {r}_{pare}^{2}}{8 μ \cdot {δ}_{m}}$$

where ε is the porosity, rₚₒᵣₑ is the pore radius, μ is the viscosity of the liquid (8.9×10⁻⁴ Pa·s for water at 25° C.), δₘ is the actual membrane thickness, δₘ=τ·l for tortuous pores, where τ is the tortuosity factor, usually 2-5 depending on the morphology, τ=1 for parallel cylindrical pores. l is the thickness.

Permeability estimation. From the rejection data of variously sized PEO molecules, a pore radius rₚₒᵣₑ=12.5 nm (dₚₒᵣₑ=25 nm) was estimated for M4. Since the morphology of the membrane M4 is network-like, the porosity and the thickness of the membrane separation layer are difficult to determine. A porosity ε=0.1 and thickness δₘ=τ·l=1.8×100 nm=180 nm was estimated, resulting in a permeability of:

Lₚ˜4000 Lm⁻²h⁻¹bar⁻¹

From this rough estimation, it is evident that a permeability of order thousands Lm⁻²h⁻¹bar⁻¹ is reasonable for the organic-inorganic membranes.

Structure factor (δₘ/ε) calculation. Assuming Lₚ=3200 Lm⁻²h⁻¹bar⁻¹, rₚₒᵣₑ=12.5 nm from the M4 membrane, the structure factor δₘ/ε was back calculated from Hagen-Poiseuille equation to be:

δₘ/ε=2.5 μm

While the disclosure has been particularly shown and described with reference to specific embodiments (some of which are preferred embodiments), it should be understood by those having skill in the art that various changes in form and detail may be made therein without departing from the spirit and scope of the present disclosure as disclosed herein.

1) An asymmetric organic-inorganic film comprising:
a multiblock copolymer having at least two blocks that microphase separate; and
a plurality of inorganic nanoparticles disposed within at least a portion of the film and on at least a portion of the film surface,
wherein the film has a surface layer having a thickness of 20 nm to 500 nm and a plurality of pores having a diameter or equivalent circular diameter of 5 nm to 100 nm in size, and
the film has a support layer having a thickness of 5 microns to 500 microns and pores having a diameter or equivalent circular diameter of 1 micron to 50 microns.

2) The asymmetric organic-inorganic film of claim 1, wherein a dimension of the pores increases in size moving away from the surface of the surface layer in contact with the support layer towards the surface of the support layer in contact with the substrate.

3) The asymmetric organic-inorganic film of claim 1, wherein a plurality of the pores in the support layer lying on a plane 20 microns from the surface layer and parallel to interface between the surface layer and support layer have a diameter or equivalent circular diameter in the plane of at least 5 microns.

4) The asymmetric organic-inorganic film of claim 1, wherein at least a portion of the pores in the support layer have an aspect ratio of greater than 2.

5) The asymmetric organic-inorganic film of claim 1, wherein at least a portion of the pore surface in the support layer is mesoporous.

6) The asymmetric organic-inorganic film of claim 1, wherein the multiblock copolymer has a PDI of 1.0 to 2.0.

7) The asymmetric organic-inorganic hybrid film of claim 1, wherein the inorganic nanoparticles are present in the film at 0.1 percent by weight to 50 percent by weight.

8) The asymmetric organic-inorganic film of claim 1, wherein the film further comprises a homopolymer and/or small molecule.

9) A method for forming an asymmetric organic-inorganic film comprising a multiblock copolymer having at least two blocks that microphase separate comprising:
a) using a deposition solution comprising the multiblock copolymer, inorganic nanoparticles, and a solvent to form an initial film comprising the multiblock copolymer, inorganic nanoparticle, and the solvent on a substrate;
b) removing a portion of the solvent from the initial film; and
c) contacting the film from b) with a phase separation solvent system, such that the asymmetric organic-inorganic film having a plurality of inorganic nanoparticles disposed within at least a portion of the film and on at least a portion of the film surface, a surface layer having a thickness of 20 nm to 500 nm and a plurality of pores having a diameter or equivalent circular diameter of 5 nm to 100 nm in size, and a support layer having a thickness of 5 microns to 500 microns and pores having a diameter or equivalent circular diameter of 1 micron to 50 microns is formed.

10) The method of claim 9, further comprising separating the asymmetric organic-inorganic film from the substrate to form a free-standing asymmetric organic-inorganic film.

11) The method of claim 9, wherein the inorganic nanoparticles are present in the deposition solution at 0.1 percent by weight to 50 percent by weight.

12) The method of claim 9, wherein the concentration of multiblock copolymer in the deposition solution is 5 percent by weight to 50 percent by weight.

13) The method of claim 9, wherein the deposition solution further comprises a homopolymer or a small molecule and the film further comprises the homopolymer or the small molecule.

14) The method of claim 9, wherein the film from b) is contacted with a vapor-phase phase separation solvent system.

15) A device comprising the film of claim 1.

16) The device of claim 15, wherein the device is a filtration device.
